(19) United States
(12) Patent Application Publication
(10) Pub. No.: US 2010/0245082 A1
(43) Pub. Date: Sep. 30, 2010

(54) Backlighting for Computer Fingerprint Reader

(75) Inventors: Aaron Michael Stewart, Raleigh, NC (US); Mark Evan Cohen, Cary, NC (US); Adam Miles Smith, Chapel Hill, NC (US); Joseph Michael Pennisi, Apex, NC (US); Masayasu Goto, Yamato-shi (JP); Yasumichi Tsukamoto, Yamato-shi (JP)

Correspondence Address: ROGITZ & ASSOCIATES, 750 B STREET, SUITE 3120, SAN DIEGO, CA, 92101, US

(73) Assignee: Lenovo (Singapore) Pte. Ltd.

(21) Appl. No.: 12/415,287

(22) Filed: Mar. 31, 2009

(51) Int. Cl. G08B 21/00; H05B 41/00; G06F 21/00

(52) U.S. Cl. 340/540; 315/313; 726/19; 340/5.83

(57) ABSTRACT

A fingerprint reader (FPR) on a computer is illuminated when an operational context of the computer renders the FPR useful for receiving tactile input from a user.

### I. FIELD OF THE INVENTION

The present invention relates generally to indicating, using lighting, when a fingerprint reader on a computer is indicated for operation.

### II. BACKGROUND OF THE INVENTION

Many computers include fingerprint readers (FPR) for authenticating identity when logging in to the computer or when entering various passwords. Because the user is not always made aware of when the FPR can be used for various functions, software prompting is required.

### SUMMARY OF THE INVENTION

As understood herein, displaying a text prompt to a user that a FPR can be used competes with other images on the computer display and cannot provide persistent indication when, e.g., the user is logged out, the system is in standby, etc. Accordingly, illumination is used to indicate when the FPR may be used, and in particular light emitting diode (LED) backlighting may be used to indicate when the FPR may be employed relative to the particular context of the computer.

Accordingly, a computer has a processor and a fingerprint reader (FPR) communicating with the processor. The processor causes the FPR to be illuminated when an operational context of the computer renders the FPR useful for receiving tactile input from a user.

In some embodiments a light emitting diode (LED) is energizable to backlight the FPR to illuminate the FPR. If desired, plural LEDs of different colors corresponding to respective different operational contexts may be provided. In addition or alternatively, a first behavior of the LED can correspond to a first operational context and a second behavior of the LED can correspond to a second operational context.

Without limitation, the operational context can include logon authentication, password entry, an incoming call, FPR navigation, and use of the FPR for power control. In another aspect, a computer has a chassis holding a processor and a computer readable storage medium accessible to the processor and bearing instructions executable by the processor to cause the processor to selectively backlight a fingerprint reader (FPR).

In another aspect, a tangible computer readable medium bears instructions executable by a processor to determine a context in which a computer currently is operating, and based on the context, selectively illuminate a fingerprint reader communicating with the processor.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting computer that can use the present invention; and

FIG. 2-6 are flow charts of non-limiting logic in accordance with present principles.

### DETAILED DESCRIPTION OF THE PREFERRED EMBODIMENT

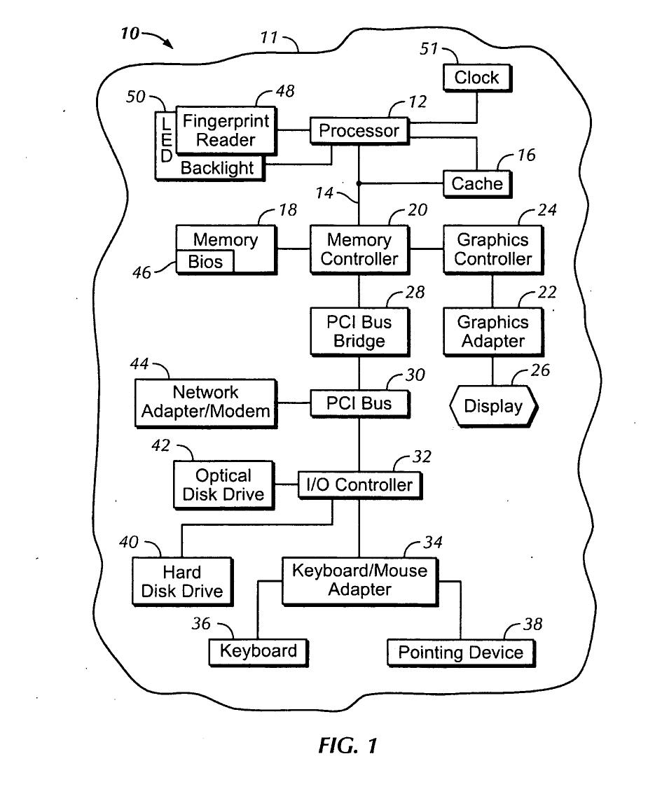

Referring initially to FIG. 1, a high level block diagram of a data processing system, generally designated 10, is shown in which the present invention may be implemented. The system 10 in one non limiting embodiment is a personal computer or laptop computer or notebook computer or personal digital assistant (PDA) having a chassis 11 containing the components shown in FIG. 1.

The system 10 includes a processor 12, which may be, without limitation, a Power PCTM processor available from Lenovo (or other processors common to the industry). The processor 12 typically is connected to a processor bus 14, and a cache 16, which is used to stage data to and from the processor 12 at reduced access latency, is also typically connected to the processor bus 14.

In non limiting embodiments the processor 12 can access data from the cache 16 or from a system solid state memory 18 by way of a memory controller function 20. The cache 16 may include volatile memory such as DRAM and the memory 18 may include non volatile memory such as flash memory. Also, the memory controller 20 may be connected to a memory mapped graphics adapter 22 by way of a graphic bus controller 24, and the graphics adapter 22 provides a connection for a monitor 26 on which the user interface of software executed within data processing system 10 is displayed.

The non limiting memory controller 20 may also be connected to a personal computer interface (PCI) bus bridge 28, which provides an interface to a PCI bus 30. Connected to the PCI bus 30 may be an input/output (I/O) controller 32 for controlling various I/O devices, including, e.g., a keyboard/mouse adapter 34 which provides connection to a keyboard 36 and to a pointing device 38, which may be implemented by a mouse, trackball, or the like. Additionally, a hard disk drive 40 may be connected to the I/O controller 32, but in some implementations no physical HDD is implemented on the system 10 itself, and the processor 12 accesses a remote disk using iSCSI as though the remote disk were a local HDD.

The HDD 40, whether local or remote, may include a controller that can access a master booth record (MBR) which can contain executable code as well as tabular data structures. If desired, an optical disk drive 42, such as a DVD or CD drive, can be connected to the I/O controller 32. In some implementations a network adapter 44 can be attached to the PCI bus 30 as shown for connecting the data processing system 10 to a local area network (LAN), the Internet, or both. In any case, in accordance with principles known in the art, during power on the processor 12 executes a basic input/output system (BIOS) program 46 that may be stored in the memory 18, to load an operating system in the hard disk drive 40 into the memory 18. A fingerprint reader (FPR) 48 may be provided on the chassis in communication with the processor 12, and one or more LEDs 50 can be provided under the FPR 48 relative to the surface of the computer facing the user. Plural LEDs each of different colors may be provided for purposes to be shortly disclosed. The LEDs may be mounted directly under the FPR, which can be transparent or translucent, so that illuminated LEDs may be visually detected through the FPR. A strip of LEDs may be provided or point instances of LEDs may be provided. A clock 51 may be provided for timing purposes.

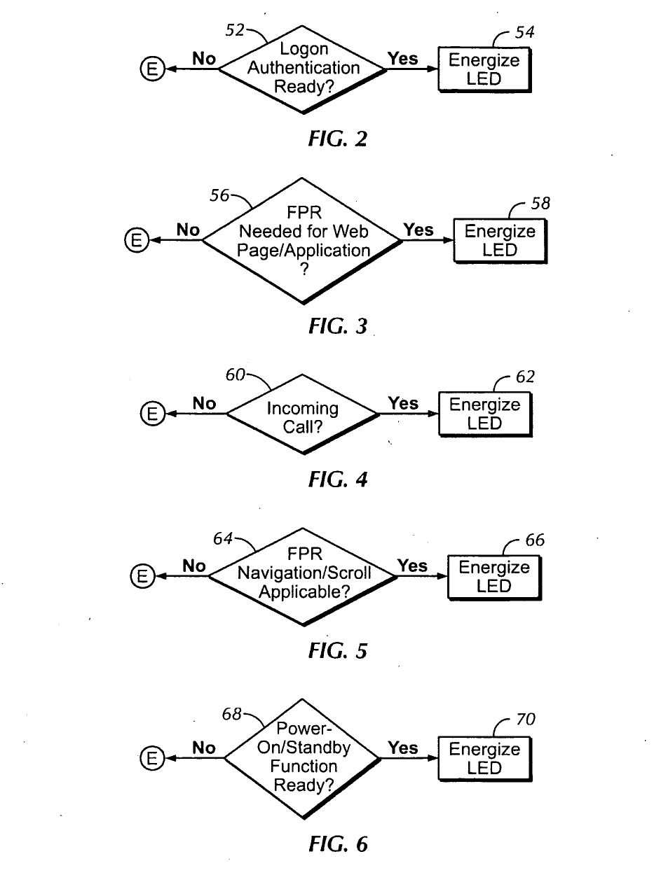

Now referring to FIG. 2, decision diamond 52 simply indicates that in the presence of the operational context of the computer being ready to receive logon authentication, at block 54 the FPR 48 is illuminated. In the embodiment shown, this is accomplished by illuminating the LED 50 upon graphical identification and authentication (GINA) and recognition of the FPR's presence by the processor 12. Absent this operational context or other operational context implicating the FPR 48, the logic ends at state “E”.

Decision diamond 56 in FIG. 3 indicates that in the presence of the operational context of a web page or application window requiring password entry, at block 58 the FPR 48 is illuminated. In the embodiment shown, this is accomplished by illuminating the LED 50 upon the screen cursor entering a password text box. Absent this operational context or other operational context implicating the FPR 48, the logic ends at state “E”.

Decision diamond 60 in FIG. 4 indicates that in the presence of the operational context of allowing a user to simultaneously authenticate and answer a voice over Internet protocol (VOIP) call if, e.g., the user is logged out of the operating system of the computer, at block 62 the FPR 48 is illuminated. In the embodiment shown, this is accomplished by illuminating the LED 50 upon receipt of the incoming call. Absent this operational context or other operational context implicating the FPR 48, the logic ends at state “E”.

Decision diamond 64 in FIG. 5 indicates that in the presence of the operational context of the FPR being available for navigation/scrolling of a screen/cursor, at block 66 the FPR 48 is illuminated. In the embodiment shown, this is accomplished by illuminating the LED 50 when the processor 12 is configured to receive navigation signals from the FPR. Absent this operational context or other operational context implicating the FPR 48, the logic ends at state “E”.

Decision diamond 68 in FIG. 6 indicates that in the presence of the operational context of the FPR being available for inputting a power-on and/or resume normal operation signal, at block 70 the FPR 48 is illuminated. In the embodiment shown, this is accomplished by illuminating the LED 50 when, e.g., the computer is in a standby (power save) mode. Absent this operational context or other operational context implicating the FPR 48, the logic ends at state “E”.

As mentioned above, plural LEDs of differing colors may be provided, with a particularly colored LED being energized for a respective operational context to in effect color code the FPR to indicate the particular context for which it is presently useful. In addition or alternately, the behavior of the LED can be correlated to the context, e.g., quickly flashing for one context, occulting for another context, on continuously for yet a third context, and so on.

For example, a green LED may be continuously illuminated to indicate that the FPR is configured to receive a finger swipe. The period for which the green LED is illuminated preferably matches the period an authentication software is configured to receive fingerprint information, and no longer or shorter, to avoid user confusion.

Then, once the user swipes his finger across the FPR, the green LED might temporarily deenergize, then re-illuminate. Further, in response to successfully validating the fingerprint pattern received from the swipe, the green LED might turn off for a short period, then turn on for a short period to indicate successful validation, then turn off until another context requires illuminating it.

On the other hand, in the event of unsuccessful validation of the fingerprint, an amber LED might flash off and on, e.g., flash three times in one second, and then deenergize, with the green LED remaining off during this period. The green LED might then illuminate to indicate that the FPR and software are configured to receive a retry at the swipe.

While the particular BACKLIGHTING FOR COMPUTER FINGERPRINT READER is herein shown and described in detail, it is to be understood that the subject matter which is encompassed by the present invention is limited only by the claims.

What is claimed is:

1. A computer comprising:
a processor; and
a fingerprint reader (FPR) communicating with the processor, the processor causing the FPR to be illuminated when an operational context of the computer renders the FPR useful for receiving tactile input from a user.

2. The computer of claim 1, comprising at least one light emitting diode (LED) energizable to backlight the FPR to illuminate the FPR.

3. The computer of claim 2, comprising plural LEDs of different colors corresponding to respective different operational contexts.

4. The computer of claim 2, wherein a first behavior of the LED corresponds to a first operational context and a second behavior of the LED corresponds to a second operational context.

5. The computer of claim 1, wherein the operational context includes logon authentication.

6. The computer of claim 1, wherein the operational context includes password entry.

7. The computer of claim 1, wherein the operational context includes an incoming call.

8. The computer of claim 1, wherein the operational context includes FPR navigation.

9. The computer of claim 1, wherein the operational context includes use of the FPR for power control.

10. Computer comprising:
chassis holding
a processor and
a computer readable storage medium accessible to the processor and bearing instructions executable by the processor to cause the processor to selectively backlight a fingerprint reader (FPR).

11. Computer of claim 10, wherein the FPR is on the chassis and is backlit by the processor according to an operational context of the computer.

12. The computer of claim 11, comprising at least one light emitting diode (LED) energizable to backlight the FPR to illuminate the FPR.

13. The computer of claim 12, comprising plural LEDs of different colors corresponding to respective different operational contexts.

14. The computer of claim 12, wherein a first behavior of the LED corresponds to a first operational context and a second behavior of the LED corresponds to a second operational context.

15. The computer of claim 11, wherein the operational context includes logon authentication.

16. The computer of claim 11, wherein the operational context includes password entry.

17. The computer of claim 11, wherein the operational context includes an incoming call.

18. The computer of claim 11, wherein the operational context includes FPR navigation.

19. The computer of claim 11, wherein the operational context includes use of the FPR for power control.

20. A tangible computer readable medium bearing instructions executable by a processor to:
determine a context in which a computer currently is operating; and
based on the context, selectively illuminating a fingerprint reader communicating with the processor.
